(19) United States
(12) Patent Application Publication
(10) Pub. No.: US 2015/0193019 A1
(43) Pub. Date: Jul. 9, 2015

(54) MOBILE APPARATUS WITH OPTICAL INDEXER, AND METHOD FOR INDEXING USING THE SAME

(71) Applicants: YUN-SHAN CHANG, (US); DA-WEI LIN, NEW TAIPEI CITY (TW)

(72) Inventor: YUN-SHAN CHANG, SAN JOSE, CA (US)

(73) Assignees: DA-WEI LIN, NEW TAIPEI CITY (TW); YUN-SHAN CHANG, SAN JOSE, CA (US)

(21) Appl. No.: 14/147,681

(22) Filed: Jan. 6, 2014

(51) Int. Cl. G06F 3/038; G06F 3/041; G06F 3/03; G01B 11/14; G06F 3/0354

(52) U.S. Cl. CPC G06F 3/0383; G01B 11/14; G06F 3/03543; G06F 3/0304; G06F 3/0412; G06F 3/0416

(57) ABSTRACT

Disclosure is to a mobile apparatus having an optical indexer, and a method for performing indexing. The mobile apparatus includes an optical indexing module for sensing a movement. A control interface is generated in simulation and displayed on the mobile apparatus as it apparatus operates as a computer mouse. In the method, the simulated control interface is initiated in the beginning. The optical indexing module is activated to perform a tracing process, in which the optical indexing module emits a light and receives, especially by the multiple sensing cells arranged in an array, the reflected light. The photo energy received by the every sensing cell within a time slot can be computed. The energy difference in the time slot is used to determine a moving direction. An indexing signal is generated by converting movement signal made by optical indexing module and control signal from the simulated control interface.

### BACKGROUND

1. Technical Field

The present invention is generally related to a mobile apparatus with optical indexer, and a method for indexing; in particular, to the mobile apparatus having the optical indexer and using software-based virtual button to perform indexing.

2. Description of Related Art

The conventional optical sensor is the sensing component such as Complementary metal-oxide-semiconductor (CMOS), or Charge-coupled Device (CCD) that converts the received light signals into electric signals. A certain optical intensity (energy) may be captured by these sensors in general. By this scheme, in addition to capturing images, a distance sensor may be implemented for the sensor is able to determine the distance from a light source. The sensor is also used to calculate the energy change with time.

An optical indexer is such as a computer mouse that is used to determine a moving track by the inside optical sensor. While a light emitted to an operative surface, a moving vector may be determined by the senor to collect the energy change within a time interval and to perform image processing. The conventional optical computer mouse is referred to FIG. 1 that depicts inner circuits. This optical mouse 10 moves over a surface 11. Within its device housing 12, the inner circuits include a circuit board 14 in addition to the essential optics elements. Further, a controller 18 used to control, sense and operate light emission, and a light source 16 and a sensor 19 are disposed on the circuit board 14.

According to the present example of the optical mouse 10, an aperture 17 directed to external surface 11 is formed on its housing 12. The circuit board 14 is disposed near the aperture 17. A light source 16 such as a laser die or LED is disposed onto the circuit board 14. The light source 16 continuously emits lights to the surface 11 with a specific angle while the optical mouse 10 operates. The shown broken line represents the path of the incident light. A sensor 19 receives reflected light from the surface 11. The sensor 19, such as a CMOS or CCD image sensor, may obtain a distribution diagram made by the reflected light. The controller 18 then obtains a moving direction of the optical mouse 10 by analyzing the energy distribution.

In the conventional technology that determines the moving track of the optical mouse 10, the surface 11 may dominate the performance of tracking the optical mouse 10 since the signals of reflected light made by the surface 11 is the essential information.

For example, the conventional optical mouse 10 may not normally operate when it moves over a transparent material or the surface (11) that hard to reflect the light. Further, the optical mouse 10 may not easily work when it moves over an undulate non-planar surface 11, for example the cloth with wrinkles.

For the purpose of light tracing, the conventional technology may not function well when the optical indexer moves over a transparent surface or the surface that not easily reflects the light. These types of surfaces may cause the failure to determine the movement.

In the conventional technologies, some of them use additional positioning measures to acquire the moving tracks, or some use additional complicated algorithm to maintain a certain ability of tracing the movement. However, theses positioning measures or algorithm may be limited to some types of surfaces because of the limitations of sensitivity, high energy consumption, and complexity. However, these technologies are not applicable to or achieve light tracing over every surface with too high or too low reflectivity.

### SUMMARY

Disclosure in the description is related to an apparatus with a touch-sensitive display which disposes an optical indexer. In view of the conventional device such the optical computer mouse adopting the optical sensor may not function well over all the surfaces with too high or low reflectivity, provided in the disclosure is related to the mobile apparatus disposed with the optical indexer having an optical sensor array. The sensor array includes a plurality of sensor cells arranged in an array. The array-formed sensor cells operate with a corresponding tracing algorithm implement the light tracing method.

The application allows the mobile apparatus in accordance with the present invention to implement great tracing capability without too much complex optical sets. In particular, the apparatus incorporates a light source such as Laser that is with great spatial coherence. The related method for controlling the cursor by the cursor control apparatus is provided to incorporate photo constructive and destructive interference patterns formed by the incident lights and the reflected lights respectively to identifying traces.

According to one embodiment of the present invention, the mobile apparatus with the optical indexer includes an optical indication module and a signal processing module.

The optical indication module includes a control unit for integrating the inner circuit signals, and one of functions made by this control unit is to generate a movement signal. The optical indication module includes a light-emitting unit having a light source used to irradiate lights through a light passage disposed on housing of the mobile apparatus. A light sensing unit is included in the module. The light sensing unit includes a sensor array composed of a plurality of sensor cells arranged in an array. The light sensing unit is used to receive the lights entering the mobile phone through the light passage. The module includes a computing unit, which is used to compute the energy received by every sensor cell within a sampling time. Then an energy difference of spatial interference within the sampling time is formed. The energy difference is used to determine a moving direction. The control unit therefore generates a movement signal.

The signal processing module of the mobile apparatus includes an interface simulation unit for simulating a control interface. The control interface is such as creating one or more control buttons or/and a wheel using software. A touch display unit is included to generate images displayed on a display. The touch display unit is also used to detect touch event so as to generate a touch signal. A signal processing unit is included. The signal processing unit generates a control signal with respect to the touch signal made by the touch display unit and the visual picture on the control interface.

The mobile apparatus has a communication unit used to communicate with a computer host. The communication unit transfers the indication signal converted from the movement signal and the control signal.

According one further embodiment of the present invention, an indexing method adapted to the mobile apparatus having the optical indexer includes initiating a simulated control interface by a software program. The simulated control interface is such as simulating one or more control buttons or/and a wheel displayed on a touch display. The simulated control interface is provided for the user to touch and control. Simultaneously, the optical indication module of the mobile apparatus initiates. The optical indication module performs process of tracing. For example, a light emitting unit of the optical indication module irradiates lights and out of the mobile apparatus through a light passage. The light sensing unit is used to receive lights reflected by an external object. In particular, the lights are received by the arrayed sensor cells. The photo energy received by the every sensor cell within a sampling time can be computed. An energy difference of spatial interference may be formed around the sampling time. An accumulated energy difference may be used to determine a moving direction of the external object.

The optical indication module in the mobile apparatus may render the movement signals according to the moving direction. The software-implemented control interface is to simulate the interface provided for the user to touch and click for generating control signal. The movement signal and control signal are converted to an indication signal which is used to indicate the movement of cursor of computer host.

In order to further understand the techniques, means and effects of the present disclosure, the following detailed descriptions and appended drawings are hereby referred, such that, through which, the purposes, features and aspects of the present disclosure can be thoroughly and concretely appreciated; however, the appended drawings are merely provided for reference and illustration, without any intention to be used for limiting the present disclosure.

### BRIEF DESCRIPTION OF THE DRAWINGS

FIG. 1 shows the inner circuits of the conventional optical mouse;

FIG. 2 shows a schematic diagram of an incident plane and the reflected light paths;

FIG. 3 shows a schematic diagram of a sensor array packaged in one integrated circuit of the cursor control apparatus in one embodiment of the present invention;

FIG. 4 shows a schematic diagram depicting a mobile apparatus having an optical indexer in one embodiment of the present invention;

FIG. 5 schematically shows the mobile apparatus in one further embodiment of the present invention;

FIG. 6 shows a schematic diagram depicting the mobile apparatus having the optical indexer according to one embodiment of the present invention;

FIG. 7 shows circuit block diagram depicting the mobile apparatus in one embodiment of the present invention;

FIG. 8 shows a flow chart illustrating the method for indexing using the mobile apparatus according to one embodiment of the present invention;

FIG. 9 shows a flow chart illustrating the method for tracing made by the mobile apparatus having the optical indexer in one embodiment of the present invention;

FIG. 10 shows a schematic diagram of the sensor array adopted by the apparatus in one embodiment of the present invention;

FIG. 11 schematically shows a layout of the sensor pixels arranged in an cursor control apparatus of the present invention;

FIG. 12 shows an exemplary diagram describing the method of light tracing in the sensor pixels in one embodiment of the present invention;

FIG. 13 shows another exemplary diagram describing the method of light tracing in the sensor pixels in another embodiment of the present invention.

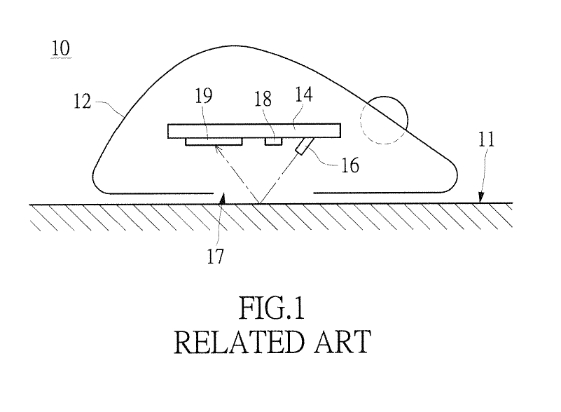

### DESCRIPTION OF THE EXEMPLARY EMBODIMENTS

Reference will now be made in detail to the exemplary embodiments of the present disclosure, examples of which are illustrated in the accompanying drawings. Wherever possible, the same reference numbers are used in the drawings and the description to refer to the same or like parts.

Disclosure is related to a mobile apparatus having the optical indexer and a method for indexing using the same. The optical indexer of the mobile apparatus exemplarily includes a sensor array essentially composed of a plurality of sensor pixels arranged in an array. In one embodiment in the disclosure, the sensor array forms an optical sensing unit which is used to receive reflected lights from a surface and converts the light signals into the energy signals for used to determining movement. While the plurality of sensor cells receive the lights, it may acquire constructive or destructive interference patterns from the energies of the reflected lights. The energy changes within a period of time may be calculated to determine a moving vector of the apparatus. The movement relative to the surface may be determined, especially to an optical indexer.

According to one preferred embodiment of the present invention, the related sensing components of the optical indexer may be disposed to the back of the apparatus. For example, while the mobile apparatus is applied to controlling cursor's movement in a computer system, a user may hand hold the mobile apparatus moving over a surface, such as desktop. When the backside of the mobile apparatus is downward to the surface, the inside sensor array may receive the lights reflected from the surface. The surface is with rough structure. The lights reflected by the surface enter the mobile apparatus, and the sensing cells receive the lights. Then the energies made by the multiple sensing cells are measured to render the interference patterns, and further obtain the energy difference made within the time slot. The any movement relative to the surface can be determined.

In particular, a coherent light or said the light with great spatial coherence is preferably applied as the light source. The coherent light allows the determination of the moving tracks to be more efficient. The determination may be cooperated with a scheme of sensitivity compensation that employs a movement recognition algorithm for light tracing. By which, the light tracing method can be applied to the various type of surfaces.

In one embodiment, a scheme of coherent light source package integration is introduced to the optical indexer of the mobile apparatus according to one embodiment of the disclosed invention. The optical indexer in the apparatus needs not to mount any additional optical lens or specific image sensor, for example the CMOS image sensor (CIS). The optical indexer in accordance with the present invention needs no any disposal of optical components such as lens and reflectors along the light path. The reflected lights may be directly received by the optical sensing cells. The energy difference within a time interval is used to detect the movement of the mobile apparatus held by the user.

The optical indexer of the mobile apparatus according to the disclosure preferably incorporates the light source with good spatial coherence, e.g. Laser. The indexer having the array-formed sensor chip is operated with a light tracing algorithm.

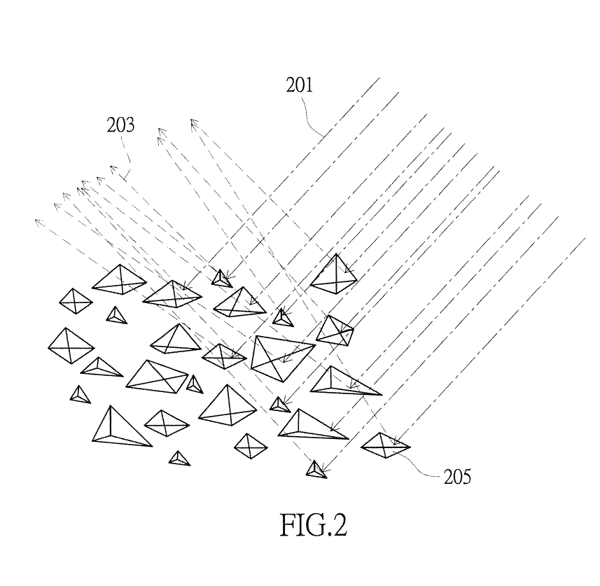

Reference is made to FIG. 2 depicting an incident light (20) made by a specific light source (not shown) emitted to a surface and then reflected (203). Therefore multiple reflected light paths expressed by the multiple lines are generated. The light source may utilize Laser, the coherent light. It is noted that the described coherent light may also be the light with great spatial coherence.

The shown multiple light paths involving the paths indicative of incident lights 201 emitted to a surface with surface structure 205, and the paths for reflected lights 203. Within a microscopic view of field, the surface structure 205 has irregular structure that causes the multi-directional reflected lights 203 as shown in the diagram.

The light source may continuously generate the incident lights 201 to the surface, and form the reflected lights 203. The reflected lights 203 are received by the sensor (not shown), in which the lights form the optical constructive and destructive interference patterns. It is particular that the light source is a coherent light source that generates the coherent incident light allowing enhancing the interference effect.

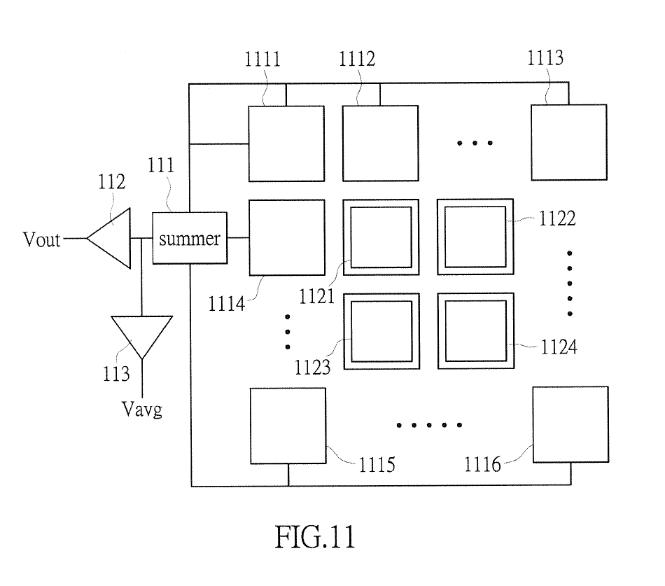

When the apparatus installed with the circuits embodying the mentioned light tracing method moves over an X-Y plane, the photo sensor receives the reflected lights 203. The apparatus samples the signals within a period of sampling time, and calculates average energy of the reflected lights. After that, an energy difference in different times or at different positions may be obtained. The optical indexer according to the disclosure may preferably incorporate a sensor array that is used to obtain the energies at the different positions, and difference between the average energies. The moving track may therefore be determined. The calculation of the statistic average may include acquiring a statistic average from the energies received by all the sensor pixels; or the average is made by part of the sensor pixels. For example, the average is referred to the sensor pixels over a row such as the X direction shown in FIG. 11; or over a column such as the Y direction. The energy average may also be calculated from the energies received by the surrounding sensor pixels or centered pixels within a specific area.

In one of the embodiments incorporating the sensor array, the interference effect may be enhanced while the light source generates coherent light. It is noted that the coherent light introduces a very small phase delay within a wave envelope. The Laser is one type of the coherent lights rather than the non-coherent light such as sunlight or LED light.

To improve sensitivity of the optical sensor under the interface made by the reflected light, the coherent light is preferably introduced to the optical indexer in the apparatus of the present invention. The coherent light may cause much small phase delay since it is featured to have less phase difference. To the spatial interference made by the non-coherent reflected light, the coherent light may cause comparative small phase delay. The coherent light may therefore advantage the spatial interference effect of the reflected light. The above-mentioned sensor array may calculate the difference of the spatial interface by the lights reflected from a surface.

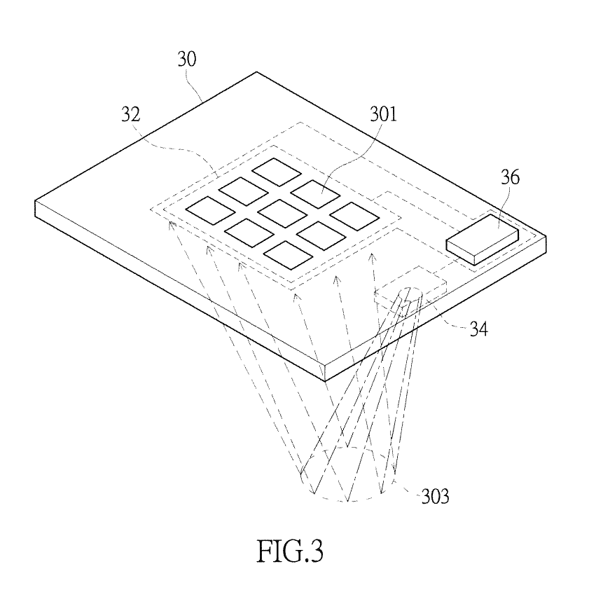

The sensor array such as the sensors shown in FIG. 3 disposed in the mobile apparatus is packaged into one IC. According to one of the embodiments, the sensor array and the related controlling circuits are integrated into one semiconductor circuit. The mentioned light source, sensor array, and the controller may be packaged onto a circuit board within the mobile apparatus where the optical indexer is embedded. Therefore, there is no need to install any optical sampling element such as lens or specific semiconductor process such as CIS so as to advance photosensitive sensitivity.

A circuit board 30 shown in the figure is installed in the mobile apparatus having the optical indexer. A sensor array 32 is mounted onto the circuit board 30 of the cursor control apparatus. The sensor array 32 includes a plurality of sensor pixels 301 arranged in an array. The sensor pixels 301 are integrated into an IC. In particular, the sensor array 32 and the controller 36 are integrated. In particular, the sensor pixels 301, especially the dummy sensor pixels shown in FIG. 11, of the sensor array 32 may be configured to have a fixed distance and an even relative position existed between two adjacent sensor pixels. The configuration allows the sensor array to receive the reflected lights evenly. The sensor pixels 301 of the sensor array 32 may evenly receive the reflected lights from their fixed positions. A light source 34 schematically emits lights onto a surface and forms the shown illuminated area 303. The lights reflected from the surface may then emit the sensor array 32. The every sensor pixel 301 receives the reflected light from different directions. A suitable photoelectric signal conversion may be applied to the signals received by the sensor pixels 301. The controller 36 and related circuit are used to measure the statistic average of the energy by firstly summing up the energies received by the sensor pixels 301. Next, the difference of the statistic average and the energy received by the every sensor pixel 301 can be obtained. The spatial interference difference made by the lights reflected from the surface can be obtained. The controller 36 may therefore determine the moving direction by accumulating multiple energy differences within a period of a sampling time.

About the spatial interference in the mentioned cursor control apparatus, especially, but not limited to, the coherent light source emits lights to the irregular surface structure of the surface and then generates the reflected lights with different directions. The optical interference is therefore produced. Interaction made between the incident lights and the reflected lights produces constructive or destructive interference patterns. The sensor array may acquire the spatial information from the interference patterns since the apparatus moves relative to the surface. The information associated to the movement over X-Y plane is therefore established.

In one embodiment, a Laser device may be introduced to be the light source of the optical indexer adopted in apparatus. In a circuit board (30), the essential elements of the apparatus include a light source (34) that is used to generate an incident light emitted to a surface; a sensor array (32) including multiple sensor pixels (301) arranged in an array; a controller (36) coupled to the light source (34) and the sensor array (32), used to receive the light signals received by the sensor pixels (301). The energy state of every sensor pixel and the difference of the energy states within the period of sampling time can be acquired.

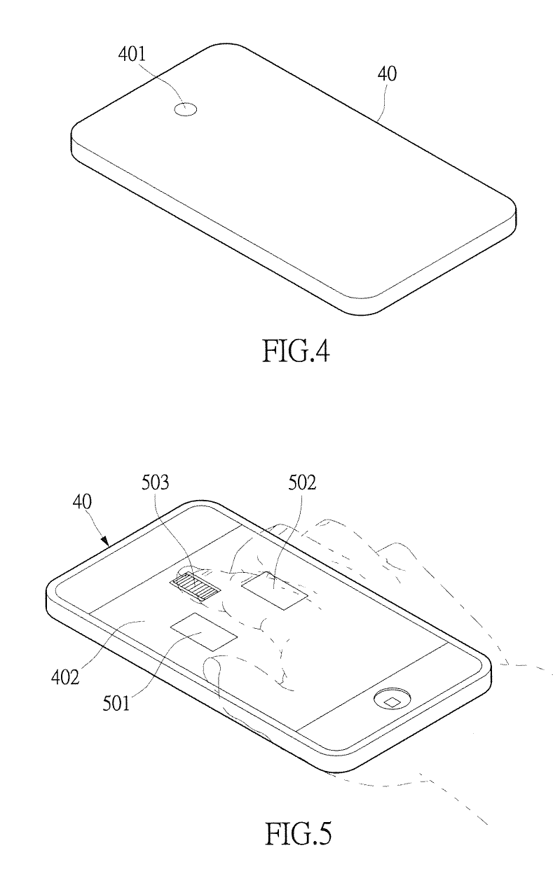

Reference is made to FIG. 4 schematically depicting a diagram of the mobile apparatus with the optical indexer according to the present invention. A mobile apparatus 40 is shown. The mobile apparatus 40 is an electronic device with a touch-sensitive display such as smart phone or tablet computer. The sensing component of the optical indexer is just disposed on the back side of the mobile apparatus 40. An opening 401 is disposed onto the back. This opening 401 is a light passage associated with the optical indexer of the apparatus 40. The optical indexer allows the mobile apparatus 40 to be operated as the conventional optical computer mouse.

FIG. 5 shows a schematic diagram depicting the mobile apparatus in accordance with the embodiment of the present invention. This mobile apparatus 40 is exemplarily equipped with a touch display. A simulated control interface is displayed in the touch display 402. Preferably, a software application such as APP is initiated to simulate the function buttons operating as the general computer mouse. The general functions are usually as the left and right buttons (first button 501, second button 502) of the conventional computer mouse. A simulated wheel 503 may also be provided as an auxiliary function button.

In practice, the user may firstly execute the software program for initiating a simulated control interface. The simulated interface includes the several control elements displayed on the display, for example the control elements are such as buttons, wheel, or any other interface enabling operations of scrolling up, down, left and right. Further the software program allows the user to define customized control elements. For example, the customized control elements made by the simulated control interface are configured to simulate the buttons aiming to the particular purposes while the software or game program is executed.

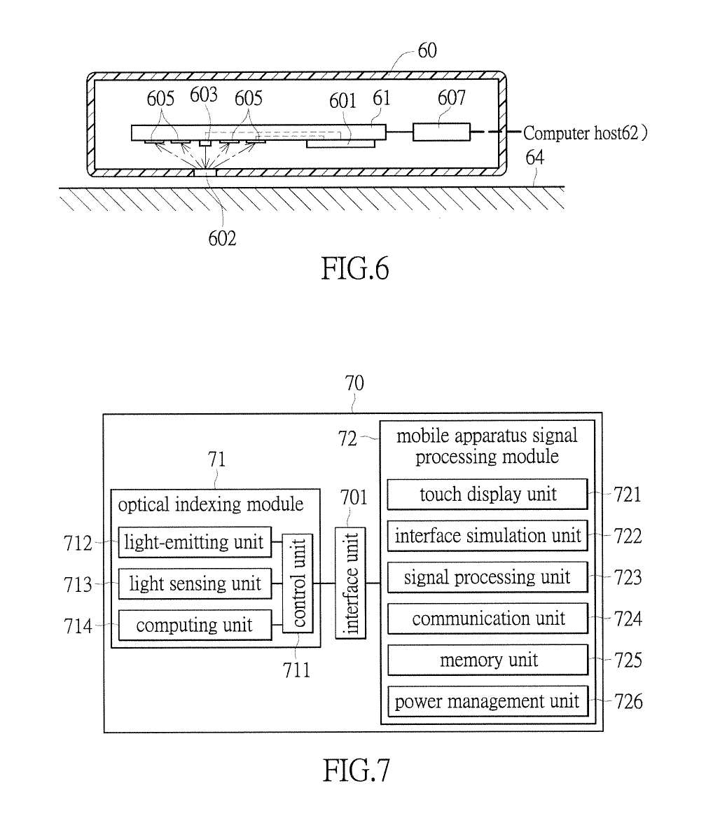

Reference is next to FIG. 6 depicting the inner circuits of the optical indexer of the mobile apparatus.

The mobile apparatus has a housing 60. A light passage 602 is disposed on the housing 60. Rather than the conventional optical indexing device requiring lens or/and mirror, the light passage 602 is just an opening allowing the external object to approach and touch. The present example shows the light passage 602 faces downward the surface 64. The position of the light passage 602 is opposite to the position of internal light source 603 for allowing the lights emitted out of the housing 60 of mobile apparatus, and receiving the reflected lights through this passage 602. Therefore the sensor array having the sensor cells arranged in an array may successfully receive the lights from the various types of surfaces 64, such as the human's skin, transparent glass or the like.

Inside the housing 60, a circuit board 61 is provided for at least mounting the sensing chip and circuits. The circuitry operates as an optical indication module which is used to perform light tracing. One of the main components mounted on the circuit board 61 is a control unit 601 which is used to integrate the inner signals made by the internal circuits and generate a movement signal. The control unit 601 is responsible for conducting communication between the optical indication module and the circuits pertinent to the mobile apparatus. For example the control unit 601 is electrically connected to the signal processing module 607 of the mobile apparatus.

A component of light source 603 is mounted on the circuit board 61. The light source 603, electrically connected to the control unit 601, is the source to emit sensing lights. The light source 603 is preferably disposed in a center of the sensor array 605 having the arrayed sensor cells. This configuration allows the sensor cells of sensor array 605 to evenly receive the reflected lights. In practice, the position of light source 603 may be adjusted as demands.

It is noted that the configuration of positions of the light passage 602 and the light source 603 may be referred to the vertical incident reflection of coherent light.

The sensor array 605 may be electrically connected to the control unit 601. When the sensor array 605 converts the received photo signals into energy signals, and the control unit 601 or other computing circuit may calculate an energy difference within a period of time. The energy difference is referred to determining a moving direction.

The signal processing module 607 of mobile apparatus electrically connected with the control unit 601 may be the original circuit module existed in the mobile apparatus. The module 607 may have an interface, as shown in FIG. 7, for receiving a movement signal made by the optical indication module. Accompanied with the control signal generated through the simulated control interface made by the signal processing module 607, an instruction may be generated for controlling cursor for the computer host 62.

According to the embodiment described in FIG. 6, the user manipulates the mobile apparatus over a surface and the opening of housing 60 is toward the surface. In the meantime, the display of the mobile apparatus may display a control interface which allows the user to operate this apparatus as a general computer mouse.

Reference is made to FIG. 7 which shows circuit block depicting the mobile apparatus with an optical indexer in accordance with one embodiment of the present invention.

Mobile apparatus 70 includes two main circuit modules, for example an optical indication module 71 and a signal processing module 72. The modules 71 and 72 are connected with a specific electric relationship. An interface unit 701 is schematically shown to describe the connection over wireless or wired means. The movement signal generated by the optical indication module 71 is transferred to the signal processing module 72 through this interface unit 701. Then the mobile apparatus 70 generates a control signal to the computer host.

The optical indication module 71 may at least include a control unit 711 which is used to integrate the internal signals made within the optical indication module 71. The control unit 711 of the optical indication module 71 is electrically connected to other circuit units. The control unit 711 generates the movement signal associated to the energy change within a period of time made by the light sensing unit.

The optical indication module 71 further includes a light-emitting unit 712 which is such as Laser with great spatial coherence, and includes some related circuits. A light source is provided to emit lights out of the housing of mobile apparatus 70 through a light passage. The optical indication module 71 includes a light sensing unit 713 having a sensor array with multiple sensor cells arranged in an array. The light sensing unit 713, especially the sensor cells, is used to receive the lights entering the mobile apparatus 70 through the light passage. A computing unit 714 in the optical indication module 71 is used to calculate the energy received within a sampling time by the every sensor cell. An energy difference of spatial interference formed around the sampling time may then be obtained so as to determine a moving direction.

In one embodiment, while the optical indication module 71 is in operation, the control unit 711 dynamically controls the emitting energy of the light-emitting unit 712. In particular, the emitting energy of the light-emitting unit 712 is adjustable in accordance with the feedback energy signal made by the sensor cells; alternatively, a lighting cycle of the light-emitting unit 712 is adjustable using pulse-width modulation as referring to the feedback energy.

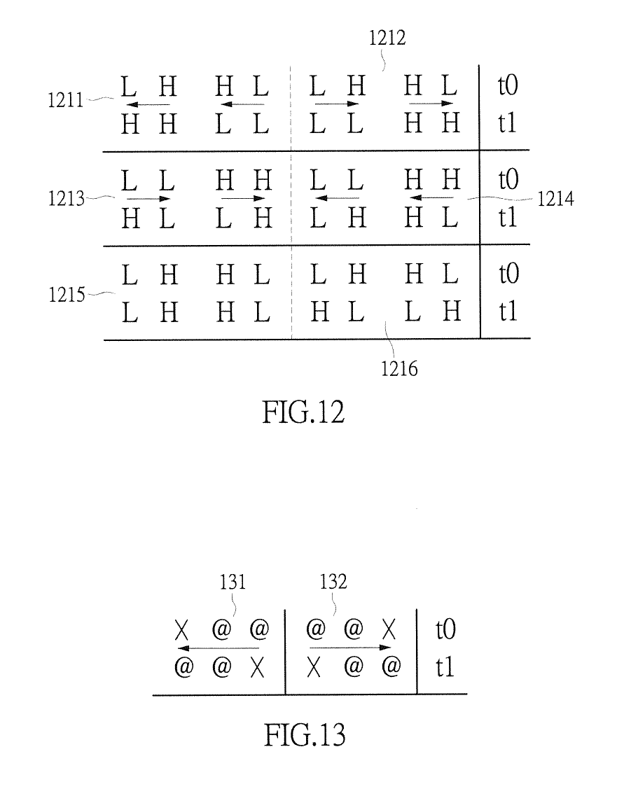

The operation of optical indication module 71 may be referred to descriptions in FIGS. 12 and 13.

The signal processing module 72 of mobile apparatus 70 includes an interface simulation unit 722. The interface simulation unit 722 may be a hardware or software-implemented module which is used to simulate a control interface displayed on display of the mobile apparatus 70. The control interface may produce various control elements as requires. For example, the control interface may produce software-implemented icons to simulate the functions of buttons and wheel. The each control element may correspond to a defined function, such as clicking, scrolling or the like.

The signal processing module 72 further includes a touch display unit 721 which is such as a driving circuit for a touch display. The touch display unit 721 creates a picture displayed on the display, and detects any touch event so as to generate a touch signal.

The signal processing module 72 further includes a signal processing unit 723, electrically connected to the touch display unit 721 and the interface simulation unit 722, used to generate a control signal according to touch signal generated by the touch display unit 721 and the corresponding visual picture of the control interface. That means, the user may manipulate this mobile apparatus as using the normal optical indexer.

Further, the mobile apparatus 70 includes a communication unit 724 which is used to connect with a computer host over wireless or wired connection. Over this connection, the mobile apparatus 70 may deliver an indication signal converted from the afore-mentioned movement signal and control signal to the computer host. The indication signal is as an instruction to control the cursor. The other circuits such as a memory unit 725 buffering the computation data and storage storing software programs for the mobile apparatus 70 may also be included. A power management unit 726 is another necessary circuit used to manage the internal circuit units of the mobile apparatus 70.

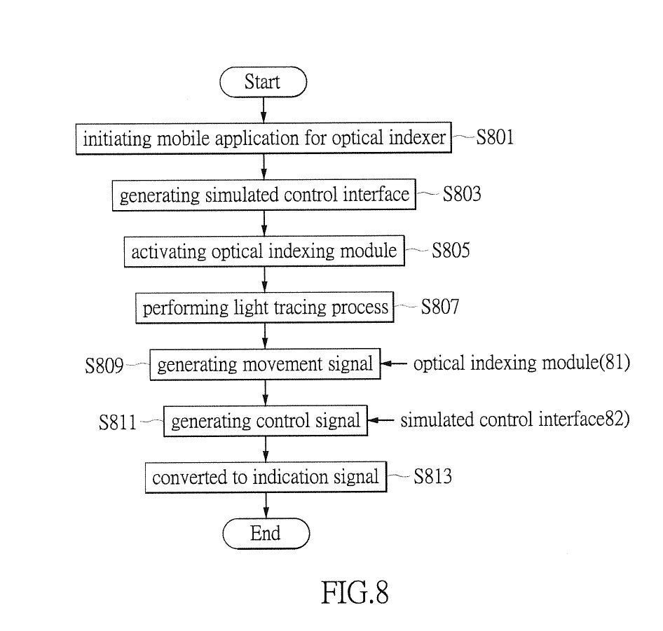

FIG. 8 next shows a flow chart illustrating an indexing method using the mobile apparatus with the optical indexer.

In the beginning, such as step S801, the system initiates a software program associated with the functions made by optical indexer. The software program is such as a mobile program (APP) installed in the mobile apparatus. The program is executed to simulate the control interface displayed on the display of the apparatus, such as step S803. The control elements in the control interface are the simulated icons for simulating the buttons, wheel, and/or user-defined buttons as the general computer mouse has.

In step S805, the optical indication module of the mobile apparatus is simultaneously activated for performing light tracing, such as step S807. That is, while the application is executed for generating the control interface, including software-implemented buttons or/and scrolling interface, the optical indication module is also activated to emit a first sensing light for determining any moving event over a surface.

In step S809, while moving the mobile apparatus with the optical indexer, the optical indication module (81) instantly computes and determines a moving direction. Then the optical indication module (81) generates a movement signal. Such as step S811, the signal processing module generates a control signal based on any touch event when the user's finger touches the simulated control interface 82 on the touch display. The control signal is then converted into an indication signal, such as step S813. The indication signal is such as the cursor control signal for the connected computer host.

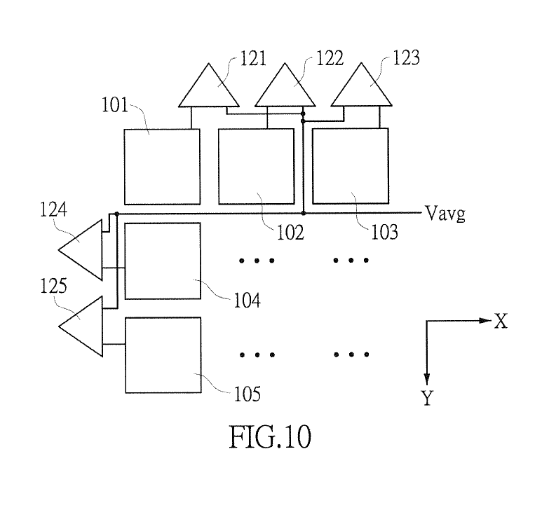

Reference is now made to FIG. 10 describing calculating a distribution of the energies received by the sensing cells in the sensor array of the optical indexer of the mobile apparatus.

Further, FIG. 10 schematically shows a layout of the sensor array. A plurality of sensor pixels are arranged over an X-Y plane to form an “N×M” sensor array. It is noted that the geometric shape of the sensor array may be, but not limited to, symmetric rectangle, square, circle, or oval-shaped. The sensor pixels 101, 102, 103, 104, and 105 are arranged in an array respectively along X and Y directions. It is noted that the practical number of the pixels is not limited to the figure. The circuit board with these sensor pixels 101, 102, 103, 104, and 105 further includes other elements such as the comparators 121, 122, 123, 124, and 125. The every comparator correspondingly associates with a sensor pixel. The input value is the average voltage signal Vavg generated by the every sensor pixel. This average voltage signal Vavg is compared with voltage signal generated by the sensor pixel as receiving the light. The comparison results in the high or low voltage value. At last, it is featured to determine the moving direction by acquiring the comparisons of the two adjacent sensors in the tracing method.

In the diagram, the shown comparator 121 is coupled to the sensor pixel 101. An input signal is such as the energy signal generated by the sensor pixel 101. The signal may be indicated by a voltage signal. The other input end shows an average voltage signal Vavg. The comparator 121 is used to compare the two inputs, and output a comparison result. In one embodiment, a binary characteristic value (H/L) is used to indicate this comparison result. The high and low voltage signals are respectively expressed by the characters H and L that as shown in FIG. 12.

According to one of the embodiments, the light tracing method applied to the optical indexer in the mobile apparatus is featured that an energy distribution over a plane is formed by depicting the constructive and destructive interference patterns of the reflected coherent lights. The change of the energy distribution at different times may be used to determine a moving vector. In an exemplary embodiment, a scheme of non-relative viewpoints is introduced to performing movement judgment. The scheme incorporates the energy information of the surrounding sensor pixels of the sensor chip to be compared with the average energy, so as to determine a moving direction. It is noted that, rather than the general method for determining the moving vector by the information extracted from the sensor pixels.

To the cursor control, in one layout of the sensor chip of an exemplary embodiment, the sensor chip includes the senor pixels arranged in an array. The sensor pixels may include some inactive sensor pixels, said dummy sensor pixels, disposed around the chip. The centered sensor pixels are the active area to receive the lights. Therefore, while the control circuit or the related calculation circuit receives the energy signals from the sensor chip, only the energies made by the non-dummy sensor pixels are adopted to perform the calculation and further application. It is noted that those dummy sensor cells would not provide the energy signals for determining the movement vector, but for verifying the light signals. Reference is made to the layout of the sensor pixels shown in FIG. 11.

The array-formed sensor pixels include some dummy sensors at surrounding area and the centered pixels. One major purpose of the disposal of the dummy sensors is to even the whole sensor chip in the manufacturing process. The energies are also received evenly by the sensor chip. In the diagram of the embodiment, the surrounding the chip are configured to be the inactive dummy sensor pixels 1111, 1112, 1113, 1114, 1115, and 1116. The sensor pixels 1121, 1122, 1123, and 1124 near the central area are the major portion to receive the signals.

When the sensor pixels are simultaneously exposed under the reflected lights, the centered pixels may evenly sense the photo signals. The surrounding sensor pixels may possibly receive uneven energies. The unstable or uncertain energies made by the dummy sensor pixels (1111, 1112, 1113, 1114, 1115, 1116) may be excluded while the total energy of the sensor chip is calculated. Therefore, this scheme allows the apparatus to acquire reference energy with better referral value.

As the diagram shows, a summation component 111, electrically connected with the every sensor pixel of the senor chip, is provided in the circuit. The summation component 111 is able to receive the photocurrent from the every sensor pixel, and perform analog-to-digital conversion thereon. In which, a gain amplification process may be introduced to efficiently receiving the reference value since the photocurrent received by the every sensor pixel is tiny. The energy change within the period of time may be obtained from the amplified energies. After that, an output signal is formed when the photocurrents made by the senor pixels are processed by the gain amplifier 112. The output is likely represented by an output voltage Vout. Through a calculator 113, an average energy can be obtained from the available received energies and outputted. The output is such as the average voltage signal Vavg.

The above-mentioned output signals such as the output voltage Vout and the average voltage signal Vavg are outputted to the comparator, e.g. comparator 621 of FIG. 6. The comparator compares the energy signal made by the every sensor pixel and a reference value such as the average energy from all or part of the sensor pixels. Therefore, an energy state for the sensor pixel is defined. For example, the energy state of every sensor pixel may be represented by a binary characteristic value “H” abbreviated from high or “L” abbreviated from low.

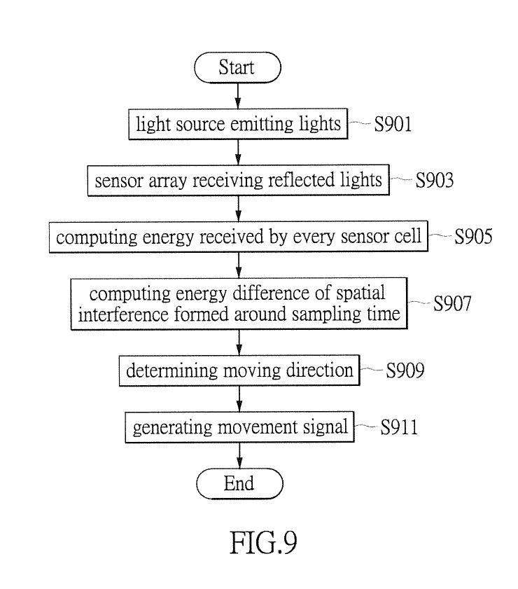

According to the operations described in the foregoing figures, the indexing method using the mobile apparatus with the optical indexer is as shown in the flow chart of FIG. 9.

In the beginning, such as step S901, the light source is driven by the driving circuit in the mobile apparatus to emit lights. The lights irradiate through the opening on the housing of the apparatus. The sensor array, especially the arrayed sensor cells, receives the lights reflected from an external object, such as step S903. The energy received by the every sensor cell within a sampling time can be calculated (step S905). While recording the energy received by the every sensor cell around the sampling time, the energy difference of spatial interference formed within the sampling time can be obtained (step S907). The energy difference is used to determine a moving direction (step S909), so as to generate a movement signal (step S911).

In the operation of determining the cursor movement, the control unit is used to dynamically adjust the energy generated by the light-emitting unit based on the information related to the energy. For example, the driving current of the light-emitting unit may be controlled for adjusting the output energy. Further, the exposure time for receiving the incident lights for every sensor cell of the light-sensing unit may also be controlled. A gain of the output energy is also an adjustable factor. The photo energy received by the every sensor cell within a time slot may be acquired. Accordingly, the scheme using the mentioned sensor array allows the mobile apparatus to adapt to the various conditions of surfaces as introducing a compensation mechanism made by the adjustable intensity and brightness of the light source with the adjustable exposure time. The various conditions of the surfaces exemplarily indicate the various surface structures and a distance between the surface and the mobile apparatus.

It is worth noting that the movement signal made by the mobile apparatus is incorporated to controlling the cursor of its connected computer host. Further, the movement signal, if taken from the mobile apparatus with a touch display, may be used with a control signal made by using a simulated control interface displayed on the touch display as the general optical indexer does.

The method to determine the moving direction by computing the change of energies within a specific time interval of every sensor cell may be referred to the schematic diagram in FIGS. 12 and 13. One of the ways to compute the change of energy made by the sensor cell is to dispose a comparator to compare the received energies and the statistic energy value. The spatial interference within the time slot is accordingly formed.

The determination of the moving vector made by the binary characteristic value (H/L) may be referred to the light tracing method exemplarily described in FIG. 12.

The exemplary diagram shows a plurality of sensor pixel groups 1211, 1212, 1213, 1214, 1215, and 1216 arranged in an array. It schematically shows the energy change between the adjacent sensor pixels at different times, e.g. first time t0 and second time t1. The energy change is used to determine the moving vector.

In FIG. 12, the time labels “t0” and “t1” represent the two sampling times. The labels “H” and “L” respectively represent the high and low voltage signals outputted by the comparator. The labels “H” and “L” indicate the two types of energy states since two energies at two moments are compared with an average. This energy state indicated of an energy change may be expressed by the binary characteristic value (H/L). The voltage signals at the different times show a transition of the movement so as to determine the overall moving vector.

For example, a sensor pixel group 1211 includes several sensor pixels at different energy states. It is shown at the left side of the diagram that the two sensor pixels are in different states at the first time t0, and exemplarily the sensor pixels respectively senses two states “L” and “H” (from left to right). The energy states “L,H” at the first time t0 are then transformed to the energy states “H,H” at the second time t1. It means the energy states of the two sensor pixels are transformed to the states “H,H” at the next moment. In which, it is determined that the energy state “L(t0)” of one of the sensor pixels is transformed to state “H(t1)”, and it appears that the energy state “H” at the right position shifts to left position at the next moment. Therefore, in accordance with the present invention, it determines that the effective moving direction is from right to left within this sampling time.

Further, the energy states of another pair of sensor pixels in this sensor pixel group 1211 are “H,L” at the first time t0; Next, at the second time t1, the energy states are transformed to next states “L,L”. In which, the energy state of one of the sensor pixels is from state “H” to state “L”. It appears that the energy state “L” at the right position shifts to left position. It therefore shows the effective moving direction is from right to left.

Next, within the sensor pixel group 1212, the energy states “L,H” of the left two sensor pixels at the first time t0 are transformed to states “L,L” at the second time t1. It shows the energy state “H” at the right position is replaced by the state “L” originally at left position. It therefore determined that the moving vector indicative of a direction from left to right.

Similarly, the energy states of the right two sensor pixels in the sensor pixel group 1212 are “H,L” at the first time t0. At the second time t1, the energy states are transformed to next states “H,H”. It shows the state “L” at the right position is replaced with the state “H” at the left position. It also determines that the moving vector indicative of the direction from left to right.

Further, there is no any arrow shown for the sensor pixel groups 1215 and 1216 after the determination shows there is no energy change therein. In which, the energy states for the sensor pixels are not changed from the first time t0 to the second time t1; or the change may not be qualified to determine any movement. For example, it is not able to determine the moving direction by this change since the energy states of the pixels in the sensor pixel group 1216 are “L,H” at the first time t0, and be transformed to “H,L” at the second time t1. Therefore, the sensor pixel group 1216 does not output any effective signal.

It consequently determines an overall moving vector by integrating all the obtained moving vectors when all the energy changes of all the sensor pixels are completely determined within the period of sampling time.

One further embodiment for determining the movement may be referred to FIG. 13. FIG. 13 shows a schematic diagram depicting the method of light tracing.

The shown aspect for recognizing the moving vector is based on the transformation of the energy states of the sensor pixels at different times. The label “X” indicates meaningless value; and label “@” shows the available sensing signal be found between the times t0 and t1. The aspect utilizes the change among the labels to determine the moving vector.

The signal energies received by the multiple sensor pixels in the sensor chip can be compared with an average at the different times while the sensor chip receives the reflected light. The comparison results in high or low voltage signal. For example, the label “@” shown in the diagram represents the available voltage signal. In some conditions, it is labeled as “X” when no energy change or no meaningful voltage signal fluctuation can be found.

In the embodiment shown in FIG. 13, in the sensor pixel group 131, the label “X@@” shows the comparator found the energy change among the adjacent sensor pixels at the first time t0. At the second time t1, the energy change made to the sensor pixels are labeled as “@@X”. When the energy state “X@@” at the first time t0 are transformed to the state “@@X” at the second time t1, it appears that the label “@@” are shifted to left position. It is therefore a leftward shift in the sensor pixel group 131 determined, as the arrow shows in the diagram.

Further, in the sensor pixel group 132, the energy state of the adjacent sensor pixels is “@@X” showing the energy change occurred at the first time t0; and the energy state is “X@@” at the second time t1. The transformation is made between the times t0 and t1, and it shows the label “@@” is rightward shifted. The method of light tracing may therefore adopt this scheme to determine the overall movement within a period of time.

It is worth noting that any tiny error made to the sensor array incorporated in the apparatus of the present invention may not influence correct determination of the movement. When the light tracing method is applied to an optical computer mouse, the slow change of the reference signals may not influence the overall determination because the shifting rate as manipulating the mouse is far lower than the processing rate of the control circuit within the apparatus.

To sum up the above description, disclosure is related to the mobile apparatus, and with sensor components and light source that are integrated into one semiconductor package. The integration effectively reduces the intrinsic noise inside the apparatus. A compensation mechanism is further provided to dynamically adjust the intensity or brightness of the light source, and adjust the exposure time accordingly. This compensation mechanism allows the mobile apparatus to adapt to various types of surfaces. Under this scheme, the mobile apparatus needs neither additional optical lens nor specific image sensor such as CMOS image sensor (CIS). It is noted that the sensor cells of the mobile apparatus directly receive the reflected lights without any intermediate optical components; particularly the energy difference within a time interval is used to detect the movement of the external object.

The above-mentioned descriptions represent merely the exemplary embodiment of the present disclosure, without any intention to limit the scope of the present disclosure thereto. Various equivalent changes, alternations or modifications based on the claims of present disclosure are all consequently viewed as being embraced by the scope of the present disclosure.

What is claimed is:

1. A mobile apparatus with an optical indexer, comprising:
an optical indexing module, comprising:
a control unit, used to integrate inner circuits signals in the optical indexing module, and generates a movement signal;
a light-emitting unit, electrically connected to the control unit, used to provide a light source to emit lights and out of the mobile apparatus through a light passage;
a light sensing unit, electrically connected to control unit, including a plurality of sensor cells arranged in an array, and receiving the lights entering the mobile apparatus through the light passage;
a computing unit, electrically connected to the control unit, used to compute energy received by the every sensor cell within a sampling time, and obtain energy difference of spatial interference formed around the sampling time, so as to determine a moving direction;
a mobile apparatus signal processing module, comprising:
an interface simulation unit, simulating a control interface displayed on a display of the mobile apparatus;
a touch display unit, used to create a picture shown on the display, and generate a touch signal when detecting any touch event;
a signal processing unit, electrically connected to the touch display unit and the interface simulation unit, used to generate a control signal by collocating the touch signal made by the touch display unit and a visual picture of the control interface.

2. The apparatus of claim 1, further comprising a communication unit, which renders a connection between the mobile apparatus and a computer host, and transfers an indication signal converted from the movement signal and the control signal.

3. The apparatus of claim 1, wherein the sensory array is configured to have a plurality of dummy cells within the normal sensor cells, and the sensory array is used to receive lights reflected by a surface through the light passage.

4. The apparatus of claim 3, wherein the sensor cells are disposed with a fixed distance and with average relative position there-between.

5. The apparatus of claim 4, wherein the dummy cells are positioned surrounding the sensor array.

6. The apparatus of claim 3, wherein the light sensing unit further comprises:
multiple comparators, each comparator is correspondingly connected to a sensor cell, and used to compare two input energy signals, in which one of the inputs is energy signal of one sensor cell, and the other one of the inputs is a statistic average of effective energies of the sensor cells, so as to calculate energy difference of spatial interference around the sampling time.

7. The apparatus of claim 1, wherein the light passage is an opening on housing of the mobile apparatus; the position of the opening is disposed opposite to the position of light source for allowing the lights emitting out of the mobile apparatus, and also incident lights being received by the arrayed sensor cells through the opening.

8. The apparatus of claim 7, wherein the light source is Laser with great spatial coherence.

9. The apparatus of claim 1, wherein the control interface is simulated to have one or more control elements.

10. A indexing method using a mobile apparatus with an optical indexer, comprising:
initiating a simulated control interface, displayed on a touch display of the mobile apparatus;
activating an optical indexing module of the mobile apparatus for performing light tracing, comprising:
a light-emitting unit of the optical index module emitting lights out of the housing of the mobile apparatus through a light passage;
a light sensing unit of the optical indexing module receiving incident lights reflected by an external object through the light passage; wherein the light sensing unit includes a plurality of sensor cells arranged in an array;
computing energy of every sensor cell within a sampling time;
obtaining an energy difference of spatial interface form around the sampling time; and
determining a relative moving direction between the mobile apparatus and the external object according to energy difference obtained within the sampling time;
the optical indexing module generating a movement signal;
the simulated control interface generating a control signal; and
converting the movement signal and the control signal into an indication signal.

11. The method of claim 10, wherein the simulated control interface is created by executing a software program in the mobile apparatus, and simultaneously activating the optical indexing module.

12. The method of claim 11, wherein the simulated control interface includes one or more software-simulated control elements.

13. The method of claim 11, wherein, the software program is used to perform conversion from the movement signal and the control signal into the indication signal.

14. The method of claim 10, wherein the light passage is an opening on the housing of the mobile apparatus, and the opening is positioned opposite to the position of the light source for allowing the light being emitted out of the mobile apparatus and receiving the reflected lights through the opening.

15. The method of claim 10, wherein the energy generated by the light-emitting unit is dynamically controlled by a control unit.

16. The method of claim 15, wherein the plurality of sensor cells include multiple dummy cells; a driving current for the light-emitting unit is adjusted in response to the energy received by the dummy cells so as to adjust the energy generated by the light-emitting unit; the control unit controls lighting cycle of the light-emitting unit by controlling duty cycle of the control signal with pulse-width modulation.

17. The method of claim 10, wherein the control unit controls the light sensing unit to receive the incident lights through the light passage, including dynamically adjusting an exposure time of the light sensing unit.

18. The method of claim 17, wherein the control unit dynamically adjusts a gain for output energy signals from the multiple sensor cells.

19. The method of claim 18, wherein the control unit controls the gain for every sensor cell according to a feedback energy signal from a sensor array having the sensor cells.

20. The method of claim 10, wherein the light sensing unit includes a plurality of comparators, and every comparator correspondingly connects to one sensor cell for comparing two input energy signals, in which one of the input energy signals is energy signal generated by the sensor cell, and the other one is a statistical average made from effective energies made by the plurality of sensor cells; an energy difference of spatial interference formed around the sampling time; wherein, a control unit of the mobile apparatus retrieves the energy signals from all or part of the sensor cells while the multiple sensor cells receive the lights, so as to calculate the statistical average.
